(19) United States
(12) Patent Application Publication
(10) Pub. No.: US 2008/0002051 A1
(43) Pub. Date: Jan. 3, 2008

(54) MOTION VECTOR DETECTING APPARATUS, MOTION VECTOR DETECTING METHOD AND INTERPOLATION FRAME CREATING APPARATUS

(75) Inventor: Ko Sato, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/751,408

(22) Filed: May 21, 2007

(30) Foreign Application Priority Data
Jun. 29, 2006 (JP) 2006-179795

(51) Int. Cl. H04N 7/12

(52) U.S. Cl. 348/416.1; 375/240.16

(57) ABSTRACT

According to one embodiment, in a motion vector detecting apparatus, a search range as a subject of block matching in an image frame is set to a restricted area constituted of a remaining area made by excluding at least one of four corner areas from a rectangular area having predetermined lengths in horizontal and vertical directions.

### CROSS-REFERENCE TO RELATED APPLICATIONS

This application is based upon and claims the benefit of priority from Japanese Patent Application No. 2006-179795, filed Jun. 29, 2006, the entire contents of which are incorporated herein by reference.

### BACKGROUND

1. Field

One embodiment of the invention relates to a motion vector detecting apparatus, a motion vector detecting method and an interpolation frame creating apparatus.

2. Description of the Related Art

Currently, various apparatuses having an image display device such as televisions, personal computers, and portable telephones are in practical use. In such an apparatus having an image display device, there is applied a technique to create an interpolation frame for interpolating each image frame from image frames constituting an input image signal, and interpolate the created interpolation frame between the image frames to display them.

This interpolation frame is created for purposes such as preventing decrease of image quality due to displaying of identical frames in a liquid crystal display apparatus, preventing a motion blur which is caused by a hold type display, and moreover displaying images smoothly using an input image signal transmitted at a low frame rate.

When such an interpolation frame is created, two image frames are divided in predetermined blocks, block matching is performed for obtaining a correlation between blocks in respective image frames, and based on the correlation obtained by the block matching, a motion vector is detected, which shows displacement between blocks having a highest correlation with each other.

Conventionally, regarding detection of such a motion vector, there have been various proposals. For example, in Japanese Patent Application Publication (KOKAI) No. 2000-134585 (Patent document 1), it is disclosed an approach to perform block matching while enlarging a search area as a predicted error gets larger when the predicted error of a vector has surpassed a predetermined value.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a configuration of an interpolation frame creating apparatus according to an embodiment of the invention;

FIG. 2 is an exemplary block diagram showing an example of an internal configuration of a motion vector detecting unit in the embodiment;

FIG. 3 is an exemplary perspective view showing two image frames to which a motion vector detecting procedure is applied and an interpolation frame in the embodiment;

FIGS. 4(a) and 4(b) are exemplary views showing restricted areas different in shape from a restricted area shown in FIG. 3, in which FIG. 4(a) shows a restricted area in a diamond shape, and FIG. 4(b) shows a restricted area in an oval shape in the embodiment;

FIGS. 5(a) and 5(b) are exemplary views showing restricted areas different in shape from the restricted areas shown in FIG. 3 and FIGS. 4(a) to 4(b), in which FIG. 5(a) shows a restricted area from which two triangular corner areas arranged at positions opposing each other are excluded, and FIG. 5(b) shows a restricted area having a downward arrow-like shape in the embodiment;

FIG. 6 is an exemplary flow chart showing an operation procedure of an interpolation frame creation processing in the interpolation frame creating apparatus in the embodiment; and

FIG. 7 is an exemplary perspective view showing two image frames to which a conventional motion vector detecting procedure is applied and an interpolation frame.

### DETAILED DESCRIPTION

Various embodiments according to the invention will be described hereinafter with reference to the accompanying drawings.

In general, according to one embodiment of the invention, in a motion vector detecting apparatus, a search range as a subject of block matching in each of image frames is set to a restricted area constituted of a remaining area made by excluding at least one of four corner areas from a rectangular area having predetermined lengths in horizontal and vertical directions.

(Configuration of Interpolation Frame Creating Apparatus)

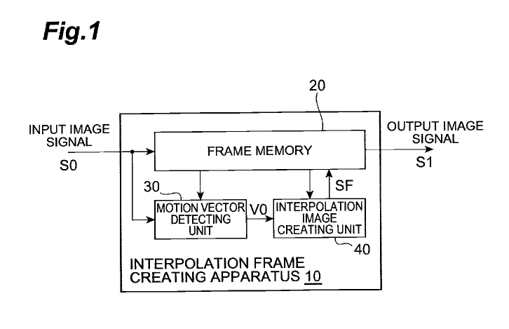

FIG. 1 is a block diagram showing a configuration of an interpolation frame creating apparatus 10 according to an embodiment of the invention. This interpolation frame creating apparatus 10 is provided in an apparatus having an image display function such as television, personal computer, and portable telephone.

This interpolation frame creating apparatus 10 is capable of creating, from a plurality of image frames constituting an input image signal SO, an interpolation frame for interpolating the plurality of image frames, and outputting an output image signal S1 in which the created interpolation frame is interpolated.

The interpolation frame creating apparatus 10 has a frame memory 20, a motion vector detecting unit 30, and an interpolation image creating unit 40.

The frame memory 20 stores the input image signal S0 by every image frame. The motion vector detecting unit 30 performs block matching for an image frame inputted without intervention of the frame memory 20 and an image frame stored in the frame memory 20 to detect a motion vector V0, and outputs the detected motion vector V0 to the interpolation image creating unit 40. Note that the configuration and operation contents of the motion vector detecting unit 30 will be described in detail later.

The interpolation image creating unit 40 creates an interpolation frame SF based on the image frame inputted without intervention of the frame memory 20 and the image frame stored in the frame memory 20 and the detected motion vector V0, and stores the created interpolation frame SF in the frame memory 20. The operation of this interpolation image creating unit 40 will also be described in detail later.

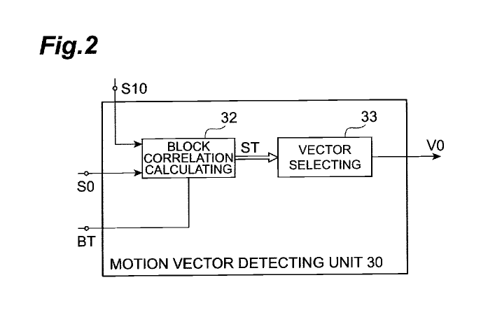

Next, a configuration of the motion vector detecting unit 30 will be described with reference to FIG. 2. FIG. 2 is a block diagram showing a configuration as an example of the motion vector detecting unit 30.

The motion vector detecting unit 30 has a block correlation calculating unit 32 and a vector selecting unit 33 as shown in FIG. 2.

The block correlation calculating unit 32 inputs the input image signal S0 and a one-frame delay signal S10, which is inputted from the frame memory 20. Then, according to timing indicated by a block timing signal BT supplied from outside, the block correlation calculating unit 32 performs block matching with two image frames being the subject, the two image frames constituting the input image signal S0 and the one-frame delay signal S10 respectively, and outputs a correlation signal ST showing a correlation between respective blocks. The correlation signal ST is outputted to the vector selecting unit 33.

In this block correlation calculating unit 32, search ranges to be the subject of the block matching are set to restricted areas 102, 202, which will be described later.

Based on the inputted correlation signal ST, the vector selecting unit 33 detects a vector value showing displacement between blocks having a highest correlation, and outputs the motion vector V0 based on the detected vector value.

Here, in the block correlation calculating unit 32 and the vector selecting unit 33, SAD (Sum of Absolute Difference of pixels) between respective blocks in a moving direction as candidates can be used as the correlation signal ST. Further, the vector selecting unit 33 can judge that a block having a smallest value of this SAD as a block having a highest correlation.

(Operation Contents of the Interpolation Frame Creating Apparatus)

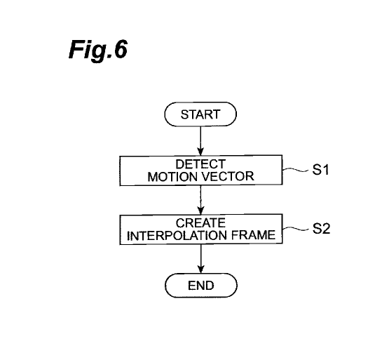

Next, operation contents of the interpolation frame creating apparatus 10 will be described. The interpolation frame creating apparatus 10 performs interpolation frame creation processing in accordance with the flowchart shown in FIG. 6 to create an interpolation frame.

When starting the interpolation frame creation processing, the interpolation frame creating apparatus 10 proceeds to block 1 to perform motion vector detection, and subsequently proceeds to block 2 to perform interpolation frame creation.

In the motion vector detection, the motion vector detecting unit 30 performs block matching of two image frames to detect a motion vector.

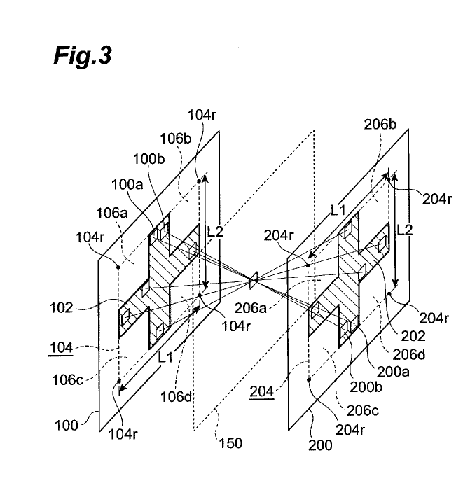

In this case, in the block correlation calculating unit 32, the block matching is performed with an image frame (previous frame) 100 constituting the input image signal S0 and an image frame (subsequent frame) 200 constituting the one-frame delay signal S10 being the subject, as shown in FIG. 3.

In this block matching, the previous frame 100 positioned temporally previously and the subsequent frame 200 positioned temporally subsequently are each divided into a plurality of image blocks, according to timing indicated by the block timing signal BT.

In this embodiment, the previous frame 100 is divided into a plurality of image blocks including image blocks 100a, 100b, and the subsequent frame 200 is divided into a plurality of image blocks including image blocks 200a, 200b. Thereafter, for the previous frame 100 and the subsequent frame 200, a correlation between respective blocks (for example, a correlation between the image block 100a and the image block 200a) is detected, and the correlation signal ST is outputted.

Then, in the interpolation frame creating apparatus 10, when the block correlation calculating unit 32 performs block matching as described above, search ranges to be the subject of the block matching are set to restricted areas 102, 202.

Here, as shown in FIG. 3, the restricted areas 102, 202 are constituted of remaining areas made by excluding four corner areas from rectangular areas 104, 204 having predetermined lengths L1, L2 in horizontal and vertical directions in the previous frame 100 and the subsequent frame 200.

The restricted area 102 shown in FIG. 3 is a remaining area (shaded area in FIG. 3) made by excluding four corner areas 106a, 106b, 106c, 106d including corners 104r of the rectangular area 104. The restricted area 202 is a remaining area (shaded area in FIG. 3) made by excluding four corner areas 206a, 206b, 206c, 206d including corners 204r of the rectangular area 204.

In the rectangular areas 104, 204 shown in FIG. 3, the corner areas 106a to 106d and 206a to 206d are all set in a rectangular shape. The restricted areas 102, 202 are remaining cross shapes made by excluding all the four corner areas 106a to 106d and 206a to 206d having such a rectangular shape from the rectangular areas 104, 204 respectively.

Then, the motion vector detecting unit 30 is configured such that the block correlation calculating unit 32 performs block matching in the restricted areas 102, 202 in the previous frame 100 and the subsequent frame 200, and does not perform the block matching in any other area than the restricted areas 102, 202.

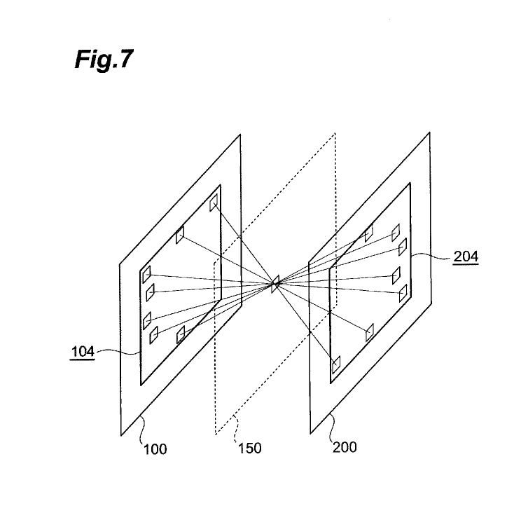

Here, in the case of a conventional interpolation frame creating apparatus, as shown in FIG. 7, the search ranges are set to rectangular areas similar to the rectangular areas 104, 204. Then, block matching is performed in two frames by moving blocks in a horizontal or vertical direction within the set areas.

When the block matching is performed in this manner, the wider the search ranges are set, the higher the possibility of finding blocks having a highest correlation in two frames. Therefore, the accuracy of a detected motion vector increases, and thereby the quality of a created interpolation frame can be increased.

However, since an amount of processing of calculations related to the block matching increases in proportion to the sizes of the search ranges, enlargement of the search ranges results in increase of the load of calculation processing related to the block matching by the amount of the enlargement. To avoid increase in the amount of processing, the search ranges must be reduced by reducing the circuit scale, suppressing an amount of software processing, and so forth. However, when the search ranges are reduced, the accuracy of a motion vector decreases, and thus the quality of an interpolation frame may decrease.

On the other hand, in an actual video displayed using the input image signal S0, other than movement of an object itself such as ball, automobile, or animal, there are a movement of a camera used for shooting in a horizontal or vertical direction, and a movement originated in scrolling in a horizontal or vertical direction of letters and/or symbols other than the object, such as Telops (letters or figures inserted in a screen of a television broadcast or the like), credits (intellectual property rights of copyrighted works or the like, names of original writers, cooperators or the like for clearly indicating sources), and sub pictures.

Regarding the movement of an object, it is hard to find regularity in moving direction thereof, and it is conceivable to have high randomness. However, a movement originated in factors other than the object, such as the above-described Telops or the like, has a strong tendency to exhibit high regularity in a right horizontal direction or a right upward or downward direction, and therefore it is conceivable that the percentage of including a movement component in a more oblique direction is relatively lower than that of the object.

Accordingly, in the interpolation frame creating apparatus 10 in this embodiment, focusing on this point, characteristics included in the above-described actual video are used to set the search ranges to the restricted areas 102, 202. By setting the search ranges to the restricted areas 102, 202, the four corner areas 106a to 106d, 206a to 206d of the rectangular areas 104, 204 are excluded from the search ranges, and therefore, by the amount of exclusion, it becomes possible to reduce the amount of processing required for a search.

However, even when the corner areas 106a, 106b, 106c, 106d are excluded from the search range, it is conceivable that the percentage of including a movement component in an oblique direction is relatively lower regarding a movement other than that of the object, and therefore, a possibility of finding a block having a high correlation can be recognized even when the block matching is performed only in the restricted areas 102, 202.

Therefore, in the interpolation frame creating apparatus 10, an amount of data processing related to the block matching can be reduced without decreasing the quality of a created interpolation frame due to decrease in accuracy of a detected motion vector.

When the correlation signal ST is outputted from the block correlation calculating unit 32 as described above, the vector selecting unit 33 detects a vector value showing displacement between blocks having a highest correlation between respective blocks based on the correlation signal ST, and then outputs the motion vector V0.

Subsequently, based on the motion vector V0 outputted from the motion vector detecting unit 30, the interpolation image creating unit 40 creates in the following manner an interpolation frame 150 which is to be interpolated between the previous frame (reference frame) 100 inputted without intervention of the frame memory 20 and the subsequent frame (standard frame, detection subject frame) 200 stored in the frame memory 20.

The interpolation image creating unit 40 determines temporal distances between respective pixel blocks in the previous frame 100 and respective pixel blocks in the subsequent frame 200, and reduces the motion vector V0 by the ratio of a temporal distance from the previous frame 200 to the interpolation frame 150 in the determined temporal distances.

Then, the interpolation image creating unit 40 makes displacement of corresponding pixel blocks in the subsequent frame 200 based on the reduced motion vector V0 to generate blocks constituting the interpolation frame 150. The interpolation image creating unit 40 repeats this procedure for each of the pixel blocks in the previous frame 100 and each of the pixel blocks in the subsequent frame 200 to thereby create the interpolation frame 150.

### MODIFICATION EXAMPLES

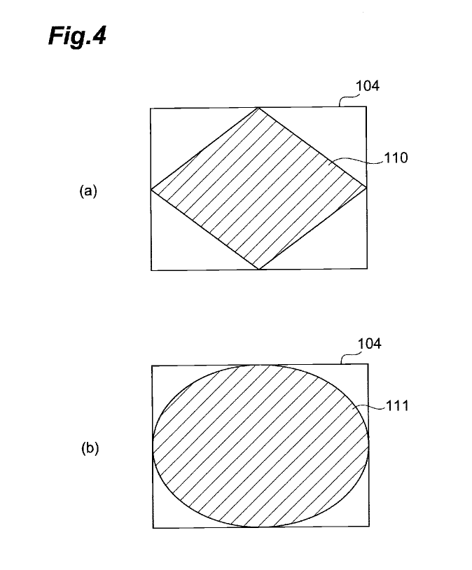

Besides the cross shape areas as above-described restricted areas 102, 202, the restricted areas may also be as follows. The restricted areas may each be a restricted area 110 in a remaining diamond shape made by excluding all four corner areas in a triangular shape as shown in FIG. 4(a), or may each be a restricted area 111 in an oval shape as shown in FIG. 4(b). Further, although not shown, the restricted areas may each be a circular shape.

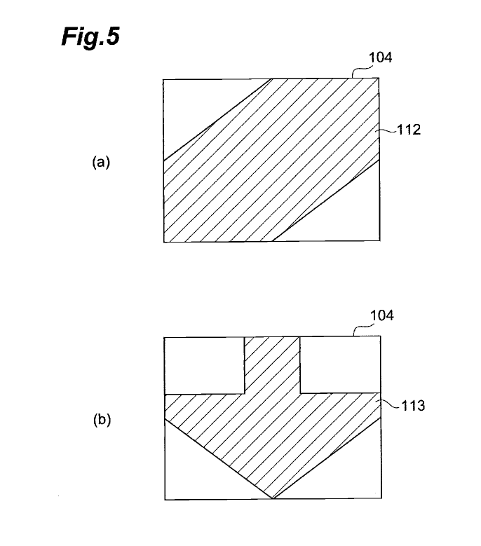

Also, the restricted areas may each be a restricted area 112 in a remaining hexagonal shape made by excluding two corner areas arranged at positions opposing each other among the four corner areas in a triangle shape as shown in FIG. 5(a), or may each be a restricted area 113 in a remaining downward arrow shape made by excluding two corner areas in a triangular shape and two corner areas in a rectangular shape as shown in FIG. 5(b).

The above explanation is for explaining the embodiments of the invention, and not to limit the apparatus and the method of the invention, and various modification examples thereof can be implemented easily. Also, any apparatus or method constructed by appropriately combining the components, functions, characteristics or method blocks in the respective embodiments are included in the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A motion vector detecting apparatus for performing block matching of a plurality of image frames to detect a motion vector,
wherein a search range as a subject of the block matching in each of the image frames is set to a restricted area constituted of a remaining area made by excluding at least one of four corner areas from a rectangular area having predetermined lengths in horizontal and vertical directions, the four corner areas including corners of the rectangular area.

2. The motion vector detecting apparatus according to claim 1,
wherein the restricted area is a remaining cross shape area made by excluding all the four corner areas in a rectangular shape.

3. The motion vector detecting apparatus according to claim 1,
wherein the restricted area is a remaining diamond shape area made by excluding all the four corner areas in a triangular shape.

4. The motion vector detecting apparatus according to claim 1,
wherein the restricted area is a circular or oval area.

5. The motion vector detecting apparatus according to claim 1,
wherein a matching device for performing the block matching performs the block matching in the restricted area in each of the image frames, and does not perform the block matching in any other area than the restricted area.

6. A motion vector detecting method for performing block matching of a plurality of image frames to detect a motion vector,
wherein the block matching is performed in a restricted area constituted of a remaining area made by excluding at least one of four corner areas from a rectangular area having predetermined lengths in horizontal and vertical directions in each of the image frames, the four corner areas including corners of the rectangular area, and the block matching is not performed in any other area than the restricted area.

7. An interpolation frame creating apparatus comprising a motion vector detecting device for performing block matching of a plurality of image frames to detect a motion vector and an interpolation frame creating device for creating an interpolation frame to be interpolated between the respective image frames based on the motion vector detected by the motion vector detecting device,
wherein in said motion vector detecting device, a search range as a subject of the block matching in each of the image frames is set to a restricted area constituted of a remaining area made by excluding at least one of four corner areas from a rectangular area having predetermined length in horizontal and vertical directions, the four corner areas including corners of the rectangular area.

8. The interpolation frame creating apparatus according to claim 7,
wherein, among the image frames, when the image frame as a subject of detection of the motion vector by said motion vector detecting device is defined as a detection subject frame, and the image frame to be referred when detecting the motion vector is defined as a reference frame, said interpolation frame creating device makes displacement of the detection subject frame based on the motion vector detected by said motion vector detecting device to create the interpolation frame.

9. The interpolation frame creating apparatus according to claim 7, further comprising
a frame memory for storing the detection subject frame,
wherein said motion vector detecting device divides the detection subject frame stored in said frame memory and the reference frame into a plurality of image blocks, and performs the block matching for each of the divided image blocks to detect the motion vector.

10. The interpolation frame creating apparatus according to claim 8, further comprising
a frame memory for storing the detection subject frame,
wherein said motion vector detecting device divides the detection subject frame stored in said frame memory and the reference frame into a plurality of image blocks, and performs the block matching for each of the divided image blocks to detect the motion vector.

11. The interpolation frame creating apparatus according to claim 7,
wherein the restricted area is one of a remaining cross shape area made by excluding all the four corner areas in a rectangular shape, a diamond shape area made by excluding all the four corner areas in a triangular shape, a circular area, and an oval area.

12. The interpolation frame creating apparatus according to claim 8,
wherein the restricted area is one of a remaining cross shape area made by excluding a all the four corner areas in a rectangular shape, a diamond shape area made by excluding all the four corner areas in a triangular shape, a circular area, and an oval area.
